(19) United States
(12) Patent Application Publication
(10) Pub. No.: US 2016/0006499 A1
(43) Pub. Date: Jan. 7, 2016

(54) APPARATUS AND METHOD FOR PREDICTION OF RADIO INTERFERENCE

(71) Applicant: ELECTRONICS AND TELECOMMUNICATIONS RESEARCH INSTITUTE, Daejeon (KR)

(72) Inventors: Nam Ho JEONG, Gongju-si (KR); Bon Jun KU, Daejeon (KR); Dae Sub OH, Daejeon (KR)

(21) Appl. No.: 14/557,872

(22) Filed: Dec. 2, 2014

(30) Foreign Application Priority Data
Jul. 1, 2014 (KR) 10-2014-0082031

(51) Int. Cl. H04B 7/185; H04B 15/00

(52) U.S. Cl. CPC H04B 7/18523; H04B 15/00

(57) ABSTRACT

The present invention relates to an apparatus and a method of predicting radio interference of a receiver. The apparatus includes a radio station information collecting unit which receives information related to a target radio station and interfering radio stations; a grouping unit which groups the interfering radio stations using the collected information; an interference parameter distribution estimating unit which models distribution characteristics of interference parameters for interfering radio stations; and an interference intensity predicting unit which predicts a distribution characteristic at least one of an interference signal intensity of a single interfering radio station and an aggregated interference signal intensity for a plurality of interfering radio stations by using a probability density function models of the interference parameters for every interference group, and predicts a total radio interference intensity from the entire interfering radio stations using the single interference signal distribution characteristic which is calculated for every group.

### CROSS-REFERENCE TO RELATED APPLICATIONS

This application claims priority to and the benefit of Korean Patent Application No. 10-2014-0082031 filed in the Korean Intellectual Property Office on Jul. 1, 2014, the entire contents of which are incorporated herein by reference.

### TECHNICAL FIELD

The present invention relates to an apparatus and a method for predicting radio interference of a receiver, and more particularly, to a technology which statistically predicts an intensity of a radio interference signal which is input to a communication link of a communication system.

### BACKGROUND ART

Radio interference between wireless communication systems may degrade a performance of a system or cause operation suspension and particularly, it is very important to precisely predict radio interference because it is realistically impossible to correct or promptly exchange a satellite system which is launched, specifically in the satellite communication link.

The radio interference is analyzed in order to examine sharing possibility or compatibility of a radio frequency with an existing system before introducing a new system in respect to spectrum management and also used to apply interference coordination technology in a system which introduces a dynamic spectrum assignment method or a coordinated multipoint (Comp) of LTE-A in real time or near real time.

However, according to a radio interference predicting technology of the related art, when the number of interference sources is increased, like interference from a terrestrial cellular mobile communication network to a satellite communication link, a time required to predict an aggregated interference intensity from multiple interference sources is increased in proportion to the number of interference sources. In order to repeatedly perform a simulation for predicting statistical distribution of an interference signal into which a mobility of a mobile communication service is reflected, additional time is required.

When a satellite is a victim receiver, a coverage of the satellite system is much broader than the terrestrial system and thus the number of interference sources to be considered is relatively increased so that a calculating time is significantly increased. In some cases, the analysis may not be performed due to an excessive memory amount of a computer which is used for the operation.

### SUMMARY OF THE INVENTION

The present invention has been made in an effort to provide an interference signal predicting apparatus and a method thereof which analyzes a system characteristic of a satellite radio station and a terrestrial radio station and an operation characteristic of a communication network to group interfering radio stations, models the interference parameters for every group by a statistical probability density function to predict distribution characteristics for an interference signal by a single interference source for every interference group which is input to a satellite uplink, an intensity of aggregated interference signal by multiple interference sources, and an aggregated interference signal intensity from the entire interfering radio stations using a probability density function for every interference parameter and a central limit theorem which is a statistical theorem.

An exemplary embodiment of the present invention provides an apparatus of predicting radio interference of a receiver, including: a radio station information collecting unit which receives system specification information and wireless network operation specification information of a target radio station and interfering radio stations which transmit a signal to the receiver, a grouping unit which groups the interfering radio stations using the collected information on the target radio station and the interfering radio stations, an interference parameter distribution estimating unit which models distribution characteristics of interference parameters for interfering radio stations for each interference group which is grouped by the grouping unit, and an interference intensity predicting unit which predicts a distribution characteristic at least one of an interference signal intensity of a single interfering radio station which belong to each interference group and an aggregated interference signal intensity for a plurality of interfering radio stations by using a probability density function of the interference parameters for every interference group, and predicts a total radio interference intensity from the entire interfering radio stations using the single interference signal distribution characteristic which is calculated for every group.

The radio station information collecting unit may receive system specification and wireless network operation specification of the satellite radio station and the terrestrial interfering radio stations which are required for interfering radio station grouping and interference parameter modeling.

The system specification of the satellite radio station and the terrestrial interfering radio station which is input to the radio station information collecting unit may include a number, a position, an output power, a center frequency, a frequency bandwidth, an antenna gain, polarization and pattern, antenna pointing, a radiation characteristic of a transmitter, and a receiving filter characteristic of a receiver, of satellite radio station and terrestrial interfering radio stations.

The wireless network operation specification which is input to the radio station information collecting unit may include a beam width, beam pointing, and a frequency assignment of the satellite network and a cell or sector size and a position, frequency assignment, and the number of radio stations per cell/sector of the terrestrial network.

The radio station information collecting unit may convert the input system specification and wireless operation specification information of the satellite radio station and the terrestrial interfering radio stations into interference parameters which are actually used for interference intensity calculation.

The interference parameters which are actually used for interference intensity calculation may include an output power of a transmitter, a transmitting antenna gain toward a receiver, a radio station insertion loss, a path loss for a distance between the transmitting radio station and the receiver, a loss which is caused by polarization mismatch between a transmitting antenna of the radio station and an antenna of the receiver, a receiving antenna gain toward the radio station, a receiver insertion loss, and a measured spectrum value which is removed based on a selectivity curve of the receiver filter.

The measured spectrum value which is removed based on the selectivity curve of the receiver filter may be calculated using a power spectral density of the interfering radio station, a frequency response of the receiver filter, and a frequency deviation between the interfering radio station and the receiver.

The measured spectrum value which is removed based on the selectivity curve of the receiver filter may be 0 dB when the channel bandwidth is the same and the frequency deviation between the interfering radio station and the receiver is zero and is increased as the frequency deviation between the interfering radio station and the receiver is increased.

The grouping unit may analyze the system characteristics of the satellite radio station and the terrestrial radio station and the operation characteristic of a communication network which are input to the radio station information collecting unit to group the interfering radio stations.

The grouping unit may analyze the distribution characteristics of the interference parameters which are converted from the system specification and the wireless operation specification information of the satellite radio station and the terrestrial interfering radio station in the radio station information collecting unit to groups the interfering radio stations.

The grouping unit may group the interfering radio stations which are located in the same beam of a satellite system or the same cell/sector of a terrestrial system, among the interfering radio stations into the same group.

The interference parameter distribution estimating unit may statistically estimate the distribution characteristic of the interference parameters for the interfering radio stations for every group to model the distribution characteristic by a probability density function.

When the interference parameter is statistically estimated, a maximum likelihood estimation method which is a statistical estimation technique which assumes that a sampled interference parameter has a specific probability distribution and finds a parameter of a probability density function which maximizes a probability of a sampled value, that is, a likelihood is used to determine a probability density function and a distribution parameter.

When the interference parameter is statistically estimated, a moment estimation method which is a statistical estimation technique which assumes that a sampled interference parameter has a probability distribution including a unknown parameter and obtains a parameter at which a moment is equal to a moment obtained from an observation value is used to determine a probability density function and a distribution parameter.

The interference intensity predicting unit may estimate an interference signal intensity from the terrestrial interfering radio stations using the probability density function of the interference parameters for every group which is estimated in the interference parameter distribution estimating unit.

A distribution of a single interference signal intensity for every group among the interference signals from the terrestrial interfering radio stations may be estimated by considering a transmitting power of the interference signal which is output from the transmitter, the transmitting antenna gain toward the receiving radio station, a transmitting radio station insertion loss, a path loss for a distance between the transmitting antenna and the receiving antenna, a loss caused by the polarization mismatch between the transmitting antenna and the receiving antenna, a receiving antenna gain toward the transmitting radio station, a receiving radio station insertion loss, and a measured spectrum value which is removed by a receiver filter selectivity curve of the receiving radio station as interference parameters.

A distribution predicting of a single interference signal intensity for every group among the interference signals from the terrestrial interfering radio stations may estimate an average, a variance, and a probability density function of a single interference signal intensity by applying a central limit theorem which is a statistical theorem, using a probability density function modeling result of the interference parameters which are estimated in the interference parameter distribution estimating unit.

A distribution predicting of an aggregated interference signal intensity among the interference signals from the terrestrial interfering radio stations may estimate an average, a variance, and a probability density function of the aggregated interference signal intensity for every interference group and entire radio stations by applying the central limit theorem which is a statistical theorem, from the single interference signal intensity prediction result.

The satellite radio station may be a multibeam based radio station in a geostationary orbit.

The interfering radio station is a transmitter which generates a signal to a satellite radio station which is connected to the satellite radio station through a different satellite network.

The interfering radio station may be a transmitter which generates a signal to a terrestrial station which is connected through a terrestrial network.

An exemplary embodiment of the present invention provides a method of predicting a radio interference including: collecting system specification information and wireless network operation specification information of a target radio station and interfering radio stations which transmit a signal to the receiver, grouping the interfering radio stations using the collected information on the target radio station and the interfering radio stations, modeling distribution characteristics of interference parameters for interfering radio stations for each interference group, predicting a distribution characteristic at least one of an interference signal intensity of the single interfering radio station which belong to each group and an aggregated interference signal intensity for a plurality of interfering radio stations by using a probability density function models of the interference parameters for every interference group, and predicting a total radio interference intensity from the entire interfering radio stations using the single interference signal distribution characteristic which is calculated for every group.

The grouping the interfering radio stations analyzes a configuration and an operating characteristic of a victim satellite communication network and an interfering terrestrial communication network to group the interfering radio stations having the same or similar interference parameter characteristic into the same group.

The grouping the interfering radio stations may group the interfering radio stations which belong to the same wireless communication network among the interfering radio stations into the same group.

The grouping the interfering radio stations may group the interfering radio stations having the same or similar path loss and pointing distribution characteristic of the transmitting and receiving antennas, among the interfering radio stations, into the same group in consideration of a size of the satellite beam and the terrestrial cell or sector.

The grouping the interfering radio stations may group the interfering radio stations having the same or similar transmitter radiation characteristic for every center frequency and frequency bandwidth of the interfering radio station into the same group in accordance with a type of the configuration of the terrestrial communication network.

The grouping the interfering radio stations may group the interfering radio stations having the same or similar output power, antenna gain distribution characteristic in accordance with the type of the terminal of the terrestrial interfering radio station into the same group.

The modeling distribution characteristics of interference parameters may repeatedly generate an interference link event using a radio station specification and position of the victim radio station and the interfering radio stations which are determined in the grouping the interfering radio stations to calculate a sample value of the interference parameters and model the interference parameter from the plurality of sample values as an arbitrary probability density function using a statistical fitting technique.

The modeling distribution characteristics of interference parameters may model the interference parameters as an arbitrary probability density function using a transmitting power of the interference signal which is output from a transmitter, a transmitting antenna gain toward a receiving radio station, a transmitting radio station insertion loss, a path loss for a distance between a transmitting antenna and a receiving antenna, a loss which is generated due to polarization mismatch between the transmitting antenna and the receiving antenna, a receiving antenna gain toward the transmitting radio station, a receiving radio station insertion loss, and a measured spectrum value which is removed by a receiver filter selectivity curve of the receiving radio station as interference parameters.

The predicting of a distribution characteristic may predict at least one of an average, a variance and a probability density function for the single interference signal intensity or the aggregated interference signal intensity by applying a central limit theorem to probability density function models of the interference parameters for the interfering radio stations for every interference group.

The predicting of a single interference signal intensity may predict the single interference signal intensity of the interfering radio station which belongs to each group using a transmitting power of the interference signal which is output from a transmitter, a transmitting antenna gain toward a receiving radio station, a transmitting radio station insertion loss, a path loss for a distance between a transmitting antenna and a receiving antenna, a loss which is generated due to polarization mismatch between the transmitting antenna and the receiving antenna, a receiving antenna gain toward the transmitting radio station, a receiving radio station insertion loss, and a measured spectrum value which is removed by a receiver filter selectivity curve of the receiving radio station as interference parameters.

According to the present invention, it is possible to analyze system characteristics and operation characteristics of satellite radio stations and a terrestrial radio stations to group interfering radio stations, statistically estimate a probability distribution characteristic of interference parameters for every group; predict a characteristic an interference signal intensity for every group using the estimated probability distribution characteristic value for every interference parameter, and predict a characteristic of an aggregated interference signal intensity from entire radio stations which is input to the satellite uplink.

According to the present invention, the interference intensity for the entire radio station is estimated from a statistical distribution characteristic of interference parameters for every group so that even though the number of interference sources is increased, it is possible to shorten a required time which takes to calculate an interference intensity as compared with existing prediction methods.

According to the present invention, a statistical distribution of an aggregated interference signal intensity by the multiple interference sources is estimated so that a flexible frequency sharing and compatible condition between the wireless systems may be provided.

### BRIEF DESCRIPTION OF THE DRAWINGS

FIG. 1 is a view illustrating a configuration of communication system to which an apparatus of predicting a radio interference of a receiver according to an exemplary embodiment of the present invention is applied.

FIG. 2 is a block diagram illustrating a configuration of an apparatus of predicting a radio interference of a receiver according to an exemplary embodiment of the present invention.

FIG. 3 is an exemplary diagram illustrating a first exemplary embodiment in accordance with generation of radio interference in a communication system according to an exemplary embodiment of the present invention.

FIG. 4 is an exemplary diagram illustrating a second exemplary embodiment in accordance with generation of radio interference in a communication system according to an exemplary embodiment of the present invention.

FIG. 5 is a flowchart illustrating an operational flow of a method of predicting radio interference according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Hereinafter, the present invention will be described in detail with reference to accompanying drawings. In this case, like components are denoted by like reference numerals in the drawings as much as possible. A detailed description of a function and/or a configuration which has been already publicly known will be omitted. In the following description, parts which are required to understand an operation according to various exemplary embodiments will be mainly described and a description on components which may cloud a gist of the description will be omitted.

Some components of the drawings will be exaggerated, omitted, or schematically illustrated. However, a size of the component does not completely reflect an actual size and thus the description is not limited by a relative size or interval of the components illustrated in the drawings.

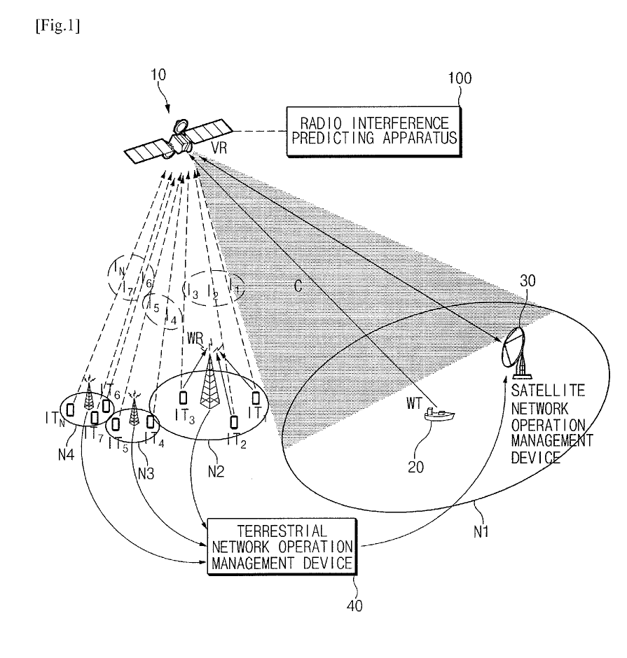

FIG. 1 is a view illustrating a configuration of a communication system to which an apparatus of predicting a radio interference of a receiver according to an exemplary embodiment of the present invention is applied.

As illustrated in FIG. 1, a communication system according to an exemplary embodiment of the present invention may include a victim receiver VR, a wanted transmitter WT, a wanted receiver WR, and an interfering transmitter IT.

The victim receiver 10 is a satellite radio station which receives a wanted signal from the wanted transmitter 20 through an uplink of a satellite communication network N1. In the meantime, the victim receiver 10 may receive a communication link signal which is transmitted from the interfering radio station of a terrestrial network to the wanted receiver due to broader coverage of the satellite network. In this case, the victim receiver 10 may receive interference signals which are generated from a plurality of terrestrial networks N2, N3, and N4.

The wanted transmitter 20 may generate a signal for communication with the victim receiver 10, to a radio station which is present within a range of the satellite network N1. Hereinafter, the wanted transmitter 20 is referred to as a “target radio station”.

In this case, the signal which is generated by the target radio station 20 is received by the victim receiver 10 through the uplink. The signal which is generated by the target radio station 20 may include information on the target radio station 20.

The wanted receiver WR receives a signal which is generated by the interfering transmitter IT. In this case, the wanted receiver WR may be a terrestrial station which is present in the terrestrial network. In the meantime, the wanted receiver WR may be a satellite radio station which is present in a satellite network different from the satellite network for communication between the victim receiver 10 and the target radio station 20.

The interfering transmitter IT is a radio station which is present in the terrestrial network and generates a signal for communication with a wanted receiver WR which is present in the terrestrial network. In the meantime, the interfering transmitter IT may be a transmitter of an earth station which is located on the ground and generates a signal for communication with a wanted receiver WR which is present in a different satellite network. The interfering transmitter IT may be a transmitter of an earth station which is located on the ground and generates a signal for communication with a victim receiver VR which is present in the same multibeam satellite network. Hereinafter, the interfering transmitter IT is referred to as an “interfering radio station”.

Here, the victim receiver 10 is considered to receive a signal through a multibeam based satellite network as a satellite radio station in a geostationary orbit. In the meantime, the victim receiver 10 may receive a signal regardless of an uplink and a downlink of single beam and/or non-geostationary orbit based satellite network and terrestrial network. However, in the description of the exemplary embodiment of the present invention, it is assumed that that the victim receiver 10 receives a signal through the geostationary orbit based multibeam satellite network.

When the victim receiver 10 communicates with the target radio station 20, if the victim receiver 10 receives a signal which is transmitted from at least one interfering radio station IT on the ground, the signal which is received from the at least one interfering radio station IT corresponds to an interfering signal which causes radio interference to communication link of the victim receiver 10. Therefore, in order to improve communication efficiency between the victim receiver 10 and the target radio station 20, the victim receiver 10 predicts an aggregated interference intensity using the interference signals I₁, I₂, I₃, . . . I_{N} of which is received from at least one interfering radio station IT to coordinate the interference in accordance with the interference signal intensity.

In this case, the coordination of the interference means that a standard or a scheme of the wanted communication link from the target radio station 20 to the victim receiver 10 is changed or a standard or a scheme of an interference communication link from the transmitting radio station IT to the target radio station 20 is changed.

Therefore, a radio interference predicting apparatus 100 which predicts radio interference of an interference signal which is received from at least one interfering radio station IT may be implemented in the target radio station 20. Of course, in some exemplary embodiment, the radio interference predicting apparatus 100 may be implemented in the victim receiver 10 or a satellite network operation management device 30 or may be separately configured.

The radio interference predicting apparatus 100 groups a plurality of interfering radio stations IT in accordance with system specification or operating specification characteristic of the target radio station 20 and the interfering radio station IT. Here, the victim receiver 10 is a geostationary satellite radio station so that an intensity of the interference signal which are generated by interfering radio stations ITs may vary depending on the number of interfering radio stations IT which are activated in a multibeam and positions thoseof. Therefore, interfering radio stations IT which are located in the same beam are grouped together in the same group or the interfering radio stations IT having an interference parameter with similar distribution may be grouped as same group.

Of course, when the interfering radio stations IT are grouped, the interfering radio stations IT in the same group are not necessarily located in the same beam. Therefore, it is obvious that the radio stations which are located in a plurality of beams can be grouped together or radio stations in the same beam may be grouped into several groups.

In this case, the radio interference predicting apparatus 100 collects information on the target radio station and the interfering radio stations from the satellite network operation management device and the terrestrial network operation management device, groups the interfering radio stations using the collected information on the target radio station and the interfering radio stations, models a distribution characteristic of interference parameters for every group to calculate a distribution characteristic of an intensity of the interference signal by the single interfering radio station which belongs to each group using the estimated probability distribution characteristic of the interference parameters for every group, and predict a total radio interference intensity by the entire interfering radio stations from the distribution characteristic of the single interference signal which is calculated for every group.

Such a radio interference predicting apparatus 100 may be implemented in a form of a module in the victim receiver 10 and may be implemented outside so as to be connected with the victim receiver 10.

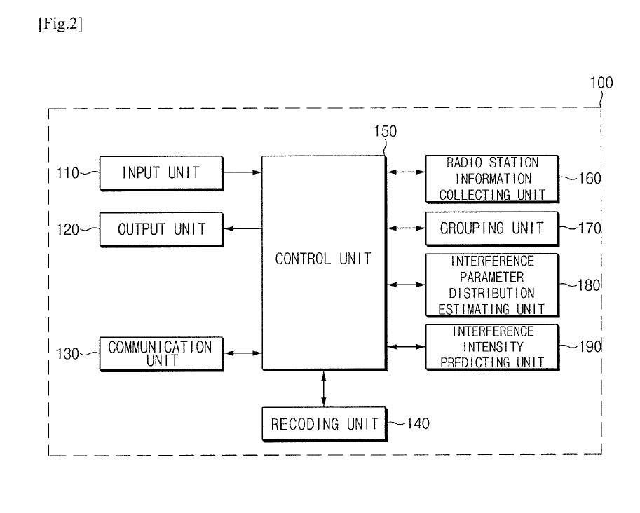

Specific description of the radio interference predicting apparatus 100 may be described in more detail with reference to FIG. 2.

FIG. 2 is a block diagram illustrating a configuration of an apparatus of predicting a radio interference of a receiver according to an exemplary embodiment of the present invention.

Referring to FIG. 2, the radio interference predicting apparatus 100 may include an input unit 110, an output unit 120, a communication unit 130, a recoding unit 140, a control unit 150, a radio station information collecting unit 160, a grouping unit 170, an interference parameter distribution estimating unit 180, and an interference intensity predicting unit 190. Here, the control unit 150 may control an operation of each unit of the radio interference predicting apparatus 100.

Here, the input unit 110 is a unit which receives system specification of the satellite radio station and the terrestrial interfering radio stations and wireless network operation specification through the satellite network operation management device 30. In this case, the terrestrial network operation management device 40 or the satellite network operation management device 30 may convert the specification into interference parameter values required to perform the interference predicting operation to transmit the interference parameter values to the input unit 110.

Here, the input unit 110 is a unit which receives a predetermined control command from a network management device. In this case, the input unit 110 may receive a setting value required to perform the radio interference predicting operation.

The output unit 120 outputs an operating state and a radio interference prediction result of the radio interference predicting apparatus 100. In this case, the output unit 120 may provide data to connected external equipment.

The communication unit 130 may include a communication module which supports a communication interface which receives a signal from the radio station.

In the recording unit 140, the setting value required for the operation of the radio interference predicting apparatus 100 may be stored and operating state information and an operating result of the radio interference predicting apparatus 100 may be stored. In the recording unit 140, information which is input through the input unit 110 may be stored and information which is obtained from the radio stations which transmit a signal to the receiver may be stored. In the meantime, in the recording unit 140, an algorithm which is required for the radio interference predicting operation may be stored. For example, in the recording unit 140, an algorithm which models an interference parameter for every group for the interfering radio stations may be stored and an algorithm which predicts an intensity of an interference signal may be stored.

When the system specification and wireless network information of the target radio station and the interfering radio stations are stored, the radio station information collecting unit 160 obtains information on the target radio station and the interfering radio stations. When the signals are received from the target radio station and a plurality of interfering radio stations through the communication unit 130, the radio station information collecting unit 160 may obtain information on the target radio station and the interfering radio stations based on the signals received through the communication unit 130. In this case, the radio station information collecting unit 160 may obtain information on the number of interfering radio stations, specification information of the target radio station and the interfering radio stations, and a wireless network operating characteristic. For example, the specification information of the target radio station and the interfering radio stations may include at least one of the number of terrestrial interfering radio stations, a position thereof, an output power, a center frequency, a frequency bandwidth, an antenna gain, polarization and pattern, an antenna pointing, a radiation characteristic of a transmitter, and a characteristic of a receiving filter of a receiver. The wireless network operating specification of the target radio station and the interfering radio station includes at least one of a beam width, a beam pointing, a frequency assignment of the satellite network and a size and a position of a cell or a sector, a frequency assignment, and a characteristic of the number of radio stations per cell/sector of the terrestrial network.

Here, the information of the number and specification of the interfering radio stations which are obtained by the radio station information collecting unit 160 is provided to the grouping unit 170 to be used in grouping of the interfering radio stations.

The grouping unit 170 groups a plurality of interfering radio stations in accordance with the wireless specification characteristic and the operation characteristic of the target radio station and the interfering radio stations.

Here, the receiver of the victim radio station according to the exemplary embodiment of the present invention is a satellite radio station in a geostationary orbit so that an intensity of an interference signal which are generated by interfering radio stations may vary depending on the number of interfering radio stations which are activated in the multibeam and the specification and the position thereof. Therefore, the grouping unit 170 analyzes the specification characteristics of the victim satellite radio station and the interference terrestrial radio station and the configuration and the operating characteristic of the communication network to group the interfering radio stations having the same or similar interference parameter characteristic into the same group.

Here, the grouping unit 170 groups the interfering radio stations which belong to the same wireless communication network among the interfering radio stations into the same group or groups the interfering radio stations having the same or similar path loss and pointing distribution characteristic of the transmitting and receiving antennas, among the interfering radio stations, into the same group in consideration of a size of the satellite beam and the terrestrial cell or sector. Alternatively, the grouping unit 170 groups the interfering radio stations having the same or similar transmitter radiation characteristic for every center frequency and frequency bandwidth of the interfering radio station into the same group in accordance with a type of the configuration of the terrestrial communication network or groups the interfering radio stations having the same or similar output power, antenna gain distribution characteristic in accordance with the type of the terminal of the terrestrial interfering radio station into the same group.

The interference parameter distribution estimating unit 180 extracts samples of the interference parameters for every group which is grouped by the grouping unit 170 and statistically fits the samples to perform the modeling. In this case, the interference parameter distribution estimating unit 180 assumes the interference parameters for every group as random variables and models the interference parameters using the probability density function based on the extracted sample.

The interference intensity predicting unit 190 calculates a ratio interference intensity which is input from the plurality of interfering radio stations to the uplink of a satellite network using the probability density function models of the interference parameters which are modeled for every group.

In this case, the interference intensity predicting unit 190 calculates an intensity of the interference signal of the interfering radio station for every group using a random value which is generated for every interference parameter from the probability density function which is modeled for every group.

Generally, when the interference parameter value is a constant number rather than a random variable, the intensity of the interference signal of the interfering radio station for every group by the single interference source may be calculated using the interference parameter of the radio station as expressed in Equation 1.

I [dBW]=P_{T}−L_{T}+G_{T}−L_{P}−L_{PM}+G_{R}−L_{R}−FDR [Equation 1]

In Equation 1, I (dBW) indicates a received interference power which is input from a single interfering radio station into the receiver, P_{T} (dBW) is a transmitting power of the interference signal which is input to the transmitter, G_{T} (dBi) is a transmitting antenna gain toward the receiver, L_{T} (dB) is a transmitter insertion loss, LP (dB) is a path loss for a distance d (km) between the transmitting radio station and the receiver, L_{PM} (dB) is a loss which is generated due to polarization mismatch between the transmitting antenna of the radio station and the antenna of the receiver, G_{R} (dBi) indicates a receiving antenna gain toward the radio station, and L_{R} (dB) indicates a receiver insertion loss.

A frequency dependent rejection (FDR) (dB) indicates a measured value of a transmitting emission spectrum which is removed based on a selectivity curve of a receiver filter. In this case, the FDR may be calculated by Equation 2.

$$FDR [ dB ] = 10 log \frac{{\int }_{0}^{∞} P ( f ) d f}{{\int }_{0}^{∞} P ( f ) {\vert H ( f + Δ f ) \vert}^{2} d f} \qquad [ Equation 2 ]$$

In Equation 2, P(f) is a power spectral density of the interfering radio station, H(f) is a frequency response of a receiver filter, and Δf indicates a frequency deviation between the interfering radio station and the receiver. In this case, in the same channel, that is, when the channel bandwidth is same and Δf is zero, the FDR is 0 dB. In general, the FDR is increased as Δf is increased.

The intensity of the interference signal which is calculated for the interfering radio station for every group is aggregated in a linear scale rather than a dB scale to calculate the intensity of the interference signal which is aggregated for the group. In this case, the aggregated intensity of the interference signals may be calculated by Equation 3.

$${I}_{aggregated} [ W ] = {I}_{1} + {I}_{2} + {I}_{3} + … + {I}_{M} = {\sum }_{j = 1}^{M} {I}_{j} \qquad [ Equation 3 ]$$

In Equation 3, Iⱼ indicates an aggregated intensity of interference signals by j-th interfering radio stations of the group.

In this case, all the aggregated intensities of the interference signal calculated for every group are added to calculate a total radio interference intensity from all the interfering radio stations.

As the example of the present invention, when the interference parameters are random variables, the interference signal intensity by the single interfering radio station for every group may be represented by a random variable having expectation/average and variance values which are expressed by Equation 4 and Equation 5.

$$\begin{matrix}\begin{matrix}E [ {I}_{i} ( dBW ) ] = E [ {P}_{Ti} - {L}_{Ti} + {G}_{Ti} - {PL}_{i} + \\ {G}_{Ri} - {L}_{Ri} - {FDR}_{i} ] \\ = E [ {P}_{Ti} ] - E [ {L}_{Ti} ] + E [ {G}_{Ti} ] - E [ {PL}_{i} ] + \\ E [ {G}_{Ri} ] - E [ {L}_{Ri} ] - E [ {FDR}_{i} ]\end{matrix} & [ Equation 4 ] \\ \begin{matrix}{σ}^{2} [ {I}_{i} ( dBW ) ] = {σ}^{2} [ {P}_{Ti} - {L}_{Ti} + {G}_{Ti} - {PL}_{i} + {G}_{Ri} - \\ {L}_{Ri} - {FDR}_{i} ] \\ = {σ}^{2} [ {P}_{Ti} ] - {σ}^{2} [ {L}_{Ti} ] + {σ}^{2} [ {G}_{Ti} ] - \\ {σ}^{2} [ {PL}_{i} ] + {σ}^{2} [ {G}_{Ri} ] - {σ}^{2} [ {L}_{Ri} ] - \\ σ [ {FDR}_{i} ]\end{matrix} & [ Equation 5 ]\end{matrix}$$

For example, the interference signal intensity (dBW) by the interfering radio station which belongs to a j-th group may have a normal distribution expressed by Equation 6 to Equation 8.

$$\begin{matrix}{f}_{norm} ( x , μ , σ ) = \frac{1}{σ \sqrt{2 π}} {e}^{- \frac{{( x - μ )}^{2}}{2 {σ}^{2}}} & [ Equation 6 ] \\ \begin{matrix}{F}_{norm} ( x , μ , σ ) = Φ \frac{( x - μ )}{σ} \\ = \frac{1}{σ \sqrt{2 π}} {\int }_{- ∞}^{x} {e}^{- \frac{{( t - μ )}^{2}}{2 {σ}^{2}}} d t \\ = \frac{1}{2} [ 1 + erf ( \frac{x - u}{σ \sqrt{2}} ) ]\end{matrix} & [ Equation 7 ] \\ erf ( z ) = - \frac{2}{\sqrt{π}} {\int }_{0}^{z} {e}^{- {t}^{2}} d t & [ Equation 8 ]\end{matrix}$$

When a random variable X having the normal distribution expressed by Equation 6 in a decibel scale is defined as x=In y in a linear scale, a random variable Y having a lognormal distribution which is expressed by Equation 9 may be obtained.

$$( {log}_{nor} ) = \frac{1}{y \sqrt{2 π} {σ}_{x}} {e}^{- {[ ln ( y ) {μ}_{x} ]}^{2} / 2 {σ}_{x}^{2}} \qquad [ Equation 9 ]$$

In this case, an average and a variance of Y may be expressed by Equation 10 and Equation 11, respectively.

μ_{y}=E[y]=e^{μ}^{ₓ}^{+σ}^{ₓ}^{²}^{/2} [Equation 10]

σ_{y}^{2=Var[y]=}e^{2μ}^{ₓ}^{+σ}^{ₓ}^{²}×(e^{σ}^{ₓ}^{²}−1) [Equation 11]

When a relational expression between the decibel scale and the linear scale of the received interference power expressed by Equation 12 is applied, a probability density function, an average, and a variance of a random variable V with respect to a single interference signal intensity for every group may be expressed by Equation 13 to Equation 15.

$$\begin{matrix} v = 10 {log}_{10} {y}^{′} & [ Equation 12 ] \\ {f}_{10 {log}_{10}} ( {y}^{′} , {μ}_{v} , {σ}_{v} ) = \frac{10}{ln ( 10 ) \sqrt{2 π} {σ}_{v} {y}^{′}} {e}^{- \frac{{[ 10 {log}_{10} {y}^{′} - {μ}_{v} ]}^{2}}{2 {σ}_{v}^{2}}} & [ Equation 13 ] \\ {μ}_{{y}^{′}} = E [ {y}^{′} ] = \frac{10}{ln ( 10 )} {10}^{{μ}_{x} + {σ}_{x}^{2} / 2} & [ Equation 14 ] \\ \begin{matrix}{σ}_{{y}^{′}}^{2} = Var [ {y}^{′} ] \\ = {( \frac{10}{ln ( 10 )} )}^{2} {e}^{2 {μ}_{x} + {σ}_{x}^{2}} \times ( {e}^{{σ}_{x}^{2}} - 1 )\end{matrix} & [ Equation 15 ]\end{matrix}$$

As another method of calculating an average and a distribution characteristic of the interference signal intensities by the single interference source for every group, there is a method which repeatedly and randomly generate interference parameters based on a probability density function for every parameter which is obtained in the interference parameter distribution estimating unit 180 and applies the interference parameter into Equation 1 to calculate an interference signal intensity expressed in the decibel scale and then collects samples for the intensity of the interference signal in the linear scale by Equation 12 and then calculates the average and the variance from the samples.

The aggregated interference signal intensity for every group may be predicted by applying a central limit theorem which is a statistic theorem, using the average and the variance value for the random variable of the inference signal intensity for every group which is calculated in the linear scale.

For example, when a random variable for a single interference signal intensity by a radio station which belongs to an i-th group is Iᵢ, if the number of interference sources is sufficiently large, a distribution characteristic of an aggregated interference signal intensity by mᵢ interference sources of the i-th group may have a normal distribution by a central limit theorem and an average and a variance may be expressed by Equation 16 and Equation 17.

E[Eᵢ_{_{—}}_{aggregated}]=mᵢ×E[Iᵢ] [Equation 16]

σ²[Iᵢ_{_{—}}_{aggregated}]=mᵢ×σ²[Iᵢ] [Equation 17]

Therefore, when the number of interference sources is sufficiently large, a distribution characteristic of a total aggregated interference signal intensity for total N radio station groups may be a normal distribution by a central limit theorem and an average and a variance may be expressed by Equation 18 and Equation 19.

$$\begin{matrix}E [ {I}_{total} ] = {\sum }_{i = 1}^{N} {m}_{i} \times E [ {I}_{i} ] & [ Equation 18 ] \\ {σ}^{2} [ {I}_{total} ] = {\sum }_{i = 1}^{N} {m}_{i} \times {σ}^{2} [ {I}_{i} ] & [ Equation 19 ]\end{matrix}$$

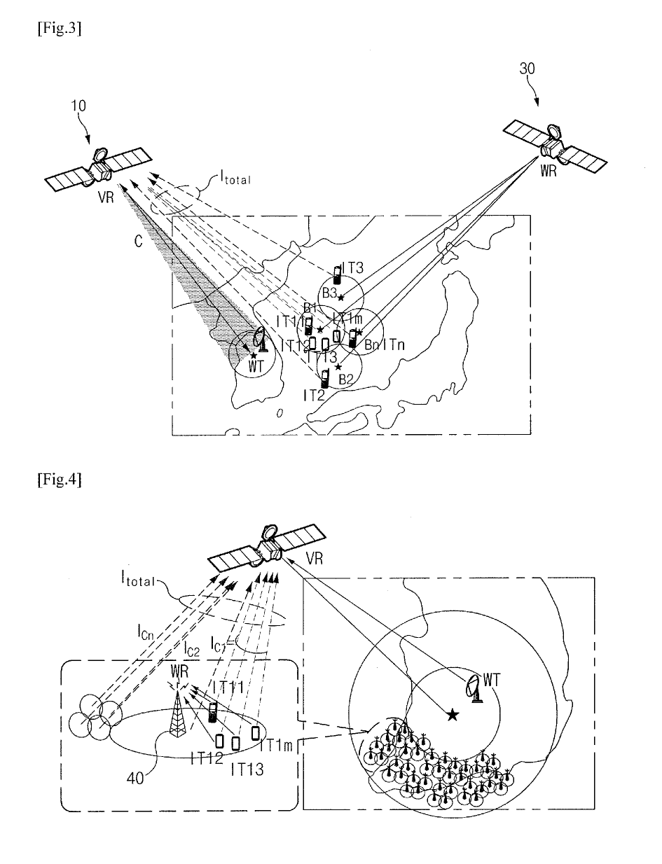

FIG. 3 is an exemplary diagram illustrating a first exemplary embodiment in accordance with generation of radio interference in a communication system according to an exemplary embodiment of the present invention. Here, FIG. 3 illustrates an interference path between satellite networks.

Referring to FIG. 3, a first satellite radio station is a receiver which performs communication with a radio station WT in a first wireless network. In the meantime, a second radio station is a receiver which performs communication with radio stations IT₁₁, . . . IT₁ₘ, IT₂, IT₃, . . . ITₙ in a second satellite network. Here, the second satellite network may include a plurality of beams B₁, B₂, B₃, . . . Bₙ.

The radio stations IT₁₁, . . . IT₁ₘ, IT₂, IT₃, . . . ITₙ transmit signals as an uplink for communication with the second satellite radio station.

Here, coverages of the first satellite network and the second satellite network may overlap and thus a signal which is transmitted from a radio station in the second satellite network may be transmitted to the first satellite radio station through the uplink of the first satellite network. In this case, the first satellite radio station may be interfered with radio signals which are input from the transmitting radio stations IT₁₁, . . . IT₁ₘ, IT₂, IT₃, . . . ITₙ to the uplink.

Accordingly, the radio interference predicting apparatus corresponding to the first satellite radio station considers IT₁₁, . . . IT₁ₘ, IT₂, IT₃, . . . ITₙ as interference sources and groups the interference sources into groups in accordance with the number of interference sources and a wireless standard.

In this case, the radio interference predicting apparatus groups the interfering radio stations which are located in the same beam into the same group or groups interfering radio stations which are expected to have a similar interference parameter distribution characteristic into groups. For example, IT₁₁, . . . IT₁ₘ among the interference sources IT₁₁, . . . IT₁ₘ, IT₂, IT₃, . . . ITₙ are interference sources which are present in the same beam B1 so as to be grouped in same group.

The radio interference predicting apparatus models the interference parameters for every group and predicts the radio interference intensity for the interference sources using a probability density function of the modeled interference parameters. Accordingly, the first satellite radio station compensates for radio interference based on the radio interference intensity for the interference sources predicted by the radio interference predicting apparatus to increase a communication efficiency.

In this case, the interference sources are classified into groups in accordance with the characteristics to calculate the interference signal intensity and the interference signal intensities of the groups are aggregated so that a required time to calculate an interference intensity is shortened.

FIG. 4 is an exemplary diagram illustrating a second exemplary embodiment in accordance with generation of radio interference in a communication system according to an exemplary embodiment of the present invention. Here, FIG. 4 illustrates an interference path between a terrestrial network and a satellite network.

Referring to FIG. 4, a satellite radio station VR is a receiver which performs communication with a radio station WT in a satellite network. In the meantime, a terrestrial station WR communicates with radio stations IT₁₁, . . . IT₁ₘ, IT₂, IT₃, . . . ITₙ in a terrestrial network.

Here, a coverage of the satellite network is broader than a coverage of the terrestrial network so that a part of the coverage of the satellite network may overlap the coverage of the terrestrial network in the satellite network. Therefore, signals which are transmitted to the terrestrial station WR by the radio stations IT₁₁, . . . IT₁ₘ, IT₂, IT₃, . . . ITₙ may be received at the satellite radio station VR through the uplink of the satellite network. In this case, the satellite radio station VR may be interfered with radio signals which are input from the transmitting radio stations IT₁₁, . . . IT₁ₘ, IT₂, IT₃, . . . ITₙ to the uplink.

Accordingly, the radio interference predicting apparatus corresponding to the satellite radio station VR considers IT₁₁, . . . IT₁ₘ, IT₂, IT₃, . . . ITₙ as interference sources and groups the interference sources in accordance with the number of interference sources and a wireless specification. In this case, the radio interference predicting apparatus groups the interference sources which are located in the same beam on the ground into the same group or groups interfering radio stations which are expected to have a similar interference parameter distribution characteristic into groups.

The radio interference predicting apparatus models the interference parameters for every group and predicts the radio interference intensity for the interference sources using a probability density function of the modeled interference parameters.

For example, an interference signal intensity I_{C1} for one group including the interference sources IT₁₁, . . . , IT₁ₘ, an interference signal intensity I_{C2} for a group including the interference source IT₂, and an interference signal intensity I_{Cn} for one group including the interference source ITₙ are calculated and a total radio interference intensity may be predicted from Iₜₒₜₐₗ obtained by adding interference signal intensities I_{C1}, I_{C2}, . . . I_{Cn} which are calculated for every groups.

Accordingly, the satellite radio station WR compensates radio interference based on the radio interference intensity for the interference sources predicted by the radio interference predicting apparatus to increase a communication efficiency.

An operation flow of the radio interference predicting apparatus of a receiver according to the exemplary embodiment of the present invention configured as described above will be described below in more detail.

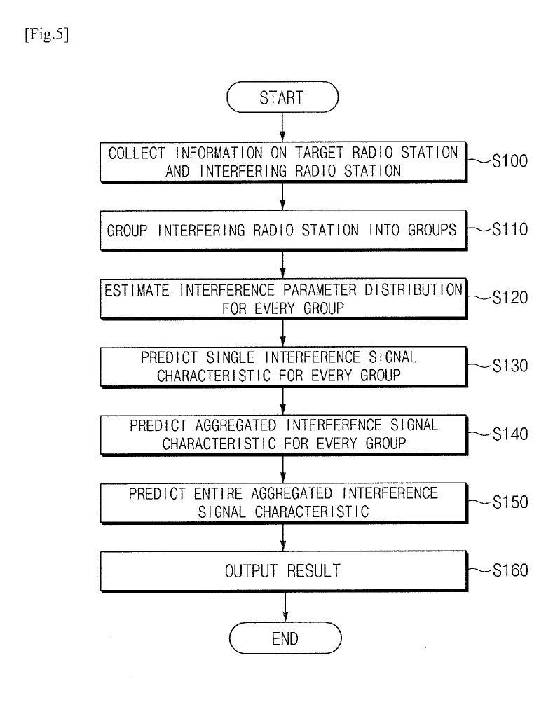

FIG. 5 is a flowchart illustrating an operational flow of a method of predicting radio interference of a receiver according to an exemplary embodiment of the present invention.

Referring to FIG. 5, a radio interference predicting apparatus may collect information on a target radio station and an interfering radio station from a terrestrial network operation management device and a satellite network operation management device through an input unit in step S100.

In step S100, the radio interference predicting apparatus may collect at least one information related with a system specification, such as the number of terrestrial interfering radio stations, a position of the radio station, an output power, a center frequency, a frequency bandwidth, an antenna gain, polarization and pattern, an antenna pointing, a radiation characteristic of a transmitting antenna, and a receiving filter characteristic of a receiving antenna and collect at least one information related with a wireless network operating specification such as a beam width, beam pointing, and a frequency assignment of the satellite network and a size of a cell or a sector, a position thereof, a frequency assignment, and a number of radio station for each cell/sector of the terrestrial network.

The radio interference predicting apparatus groups the interfering radio stations using information on the target radio station and the interfering radio station, which is collected in step S100, in step S110. In step S110, the radio interference predicting apparatus groups a plurality of interfering radio stations in accordance with the wireless specification characteristic and the operation characteristic of the target radio station and the interfering radio stations. For example, the radio interference predicting apparatus groups the interfering radio stations which belong to the same wireless communication network among the interfering radio stations into the same group or groups the interfering radio stations having the same or similar path loss and pointing distribution characteristic of the transmitting and receiving antennas, among the interfering radio stations, into the same group in consideration of a size of the satellite beam and the terrestrial cell or sector. The radio interference predicting apparatus may group the interfering radio stations having the same or similar transmitter radiation characteristic for every center frequency and frequency bandwidth of the interfering radio station into the same group in accordance with a type of the configuration of the terrestrial communication network or group the interfering radio stations having the same or similar output power and antenna gain distribution characteristic in accordance with the type of the terminal of the terrestrial interfering radio station into the same group.

The radio interference predicting apparatus may model a distribution characteristic of interference parameters for the interfering radio stations for every interference group, which is grouped in step S110, in step S120. In this case, the radio interference predicting apparatus statistically estimates the distribution characteristic of the interference parameters for the interfering radio stations for every group to model the distribution characteristic by a probability density function. Here, the radio interference predicting apparatus may determine the probability density function for the interference parameter of the interfering radio stations for every group and the distribution parameter using maximum likelihood estimation method and also determine the probability density function for the interference parameter of the interfering radio stations for every group and the distribution parameter using a moment estimation method.

Next, the radio interference predicting apparatus predicts a single interference signal characteristic for the interfering radio station for every group using a statistical characteristic including a probability density function of the interference parameters for every interference group in step S130, predicts an aggregated interference signal characteristic for a plurality of interfering radio stations in step S140, and calculates an aggregated interference signal characteristic for entire interfering radio stations in step S150.

In this case, the radio interference predicting apparatus outputs results calculated in steps S130 to S150 in step S160.

When the various exemplary embodiments described above are executed by one or more computers or processors, the present invention may be implemented as a code which is readable by a processor in a process readable recording medium. The process readable recording medium includes all types of recording devices in which data readable by a processor are stored. Examples of a process readable recording medium include an ROM, a RAM, a CD-ROM, a magnetic tape, a floppy disk, and an optical data storing device and also include a medium which is implemented as a carrier wave such as the transmitting through the Internet. The processor readable recording medium is distributed in computer systems connected through a network and the processor readable code is stored therein and executed in a distributed manner.

The specified matters and limited exemplary embodiments and drawings such as specific elements in the present invention have been disclosed for broader understanding of the present invention, but the present invention is not limited to the exemplary embodiments, and various modifications and changes are possible by those skilled in the art without departing from an essential characteristic of the present invention. Therefore, the spirit of the present invention is defined by the appended claims rather than by the description preceding them, and all changes and modifications that fall within metes and bounds of the claims, or equivalents of such metes and bounds are therefore intended to be embraced by the range of the spirit of the present invention.

What is claimed is:

1. An apparatus of predicting a radio interference of a receiver, the apparatus comprising:
a radio station information collecting unit which receives system specification information and wireless network operation specification information of a target radio station and interfering radio stations which transmit a signal to the receiver;
a grouping unit which groups the interfering radio stations using the collected information on the target radio station and the interfering radio stations;
an INTERFERENCE PARAMETER DISTRIBUTION ESTIMATING UNIT which models distribution characteristics of interference parameters for interfering radio stations for each interference group which is grouped by the grouping unit; and
an INTERFERENCE INTENSITY PREDICTING UNIT which predicts a distribution characteristic at least one of an interference signal intensity of a single interfering radio station which belong to each interference group and an aggregated interference signal intensity for a plurality of interfering radio stations by using a probability density function of the interference parameters for every interference group, and predicts a total radio interference intensity from the entire interfering radio stations using the single interference signal distribution characteristic which is calculated for every group.

2. The apparatus of claim 1, wherein the grouping unit groups interfering radio stations which are located in the same beam of a satellite system and interfering radio stations which are located in the same cell of a terrestrial system, among the interfering radio stations, into the same group, respectively.

3. The apparatus of claim 1, wherein the grouping unit groups the interfering radio stations based on a distribution characteristic difference for the interference parameters of the interfering radio stations.

4. The apparatus of claim 1, wherein the interference parameter distribution estimating unit statistically estimates a distribution characteristic of the interference parameters for the interfering radio stations for every group to be modeled by a probability density function.

5. The apparatus of claim 4, wherein the interference parameter distribution estimating unit determines a probability density function for an interference parameter of the interfering radio stations for every group and a distribution parameter using a maximum likelihood estimation method.

6. The apparatus of claim 4, wherein the interference parameter distribution estimating unit determines a probability density function for an interference parameter of the interfering radio stations for every group and a distribution parameter using a moment estimation method.

7. The apparatus of claim 1, wherein the interference parameters includes at least one of a transmitting power of the interference signal which is output from a transmitting radio station, a transmitting antenna gain toward a receiving radio station, a transmitting radio station insertion loss, a path loss for a distance between a transmitting antenna and a receiving antenna, a loss which is generated due to polarization mismatch between the transmitting antenna and the receiving antenna, a receiving antenna gain toward the transmitting radio station, a receiving radio station insertion loss, and a measured spectrum value which is removed by a receiver filter selectivity curve of the receiving radio station.

8. The apparatus of claim 7, wherein the interference intensity predicting unit predicts at least one of an average, a variance, and a probability density function of a single interference signal by applying a central limit theorem to probability density function models of the interference parameters for the interfering radio stations for every interference group.

9. The apparatus of claim 8, wherein the interference intensity predicting unit predicts at least one of an average, a variance, and a probability density function of aggregated interference signal intensity for every group and for entire radio stations by applying a central limit theorem to a estimating result of a distribution characteristic for the single interference signal intensity.

10. The apparatus of claim 7, wherein the measured spectrum value which is removed based on the selectivity curve of the receiver filter is calculated using a power spectral density of the interfering radio station, a frequency response of the receiver filter, and a frequency deviation between the interfering radio station and the receiver.

11. The apparatus of claim 7, wherein the measured spectrum value which is removed based on the selectivity curve of the receiver filter is 0 dB when the channel bandwidth is the same and the frequency deviation between the interfering radio station and the receiver is zero and is increased as the frequency deviation between the interfering radio station and the receiver is increased.

12. The apparatus of claim 1, wherein the system specification information of the target radio station and the interfering radio station includes at least one of the number of terrestrial interfering radio stations, a position thereof, an output power, a center frequency, a frequency bandwidth, an antenna gain, polarization and pattern, antenna pointing, a radiation characteristic of the interfering radio stations, and a receiving filter characteristic of the receiver.

13. The apparatus of claim 1, wherein operation specification information of the wireless network includes at least one of a beam width, beam pointing, and a frequency assignment of a satellite network and a cell size, a position, a frequency assignment, and the number of radio stations per cell of a terrestrial network.

14. The apparatus of claim 1, wherein the interfering radio station is a transmitter which generates a signal to a satellite radio station which is connected with a satellite network to which the receiver is connected, through a different satellite network.

15. The apparatus of claim 1, wherein the interfering radio station is a transmitter which generates a signal to a terrestrial station which is connected through a terrestrial network.

16. A method of predicting a radio interference, the method comprising:
collecting system specification information and wireless network operation specification information of a target radio station and interfering radio stations which transmit a signal to the receiver;
grouping the interfering radio stations using the collected information on the target radio station and the interfering radio stations;
modeling distribution characteristics of interference parameters for interfering radio stations for each interference group;
predicting a distribution characteristic at least one of an interference signal intensity of the single interfering radio station which belong to each group and an aggregated interference signal intensity for a plurality of interfering radio stations by using a probability density function models of the interference parameters for every interference group; and
predicting a total radio interference intensity from the entire interfering radio stations using the single interference signal distribution characteristic which is calculated for every group.

17. The method of claim 16, wherein the grouping the interfering radio stations, groups interfering radio stations which are located in the same beam of a satellite system and interfering radio stations which are located in the same cell of a terrestrial system, among the interfering radio stations, into the same group, respectively.

18. The method of claim 16, wherein the grouping the interfering radio stations, groups the interfering radio stations into groups based on a distribution characteristic difference for the interference parameters of the interfering radio stations.

19. The method of claim 16, wherein the modeling of interference parameters statistically estimates a distribution characteristic of the interference parameters for the interfering radio stations for every group to be modeled by a probability density function.

20. The method of claim 16, wherein the predicting of a distribution characteristic predicts at least one of an average, a variance and a probability density function for the single interference signal intensity or the aggregated interference signal intensity by applying a central limit theorem to probability density function models of the interference parameters for the interfering radio stations for every interference group.
